(19) United States
(12) Patent Application Publication
(10) Pub. No.: US 2009/0128944 A1
(43) Pub. Date: May 21, 2009

(54) Hard disk drive tunneling magnetoresistive annealing heads with a fly on demand heater

(75) Inventors: Eunkyu Jang, San Jose, CA (US); Kiseok Moon, Pleasanton, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/986,367

(22) Filed: Nov. 20, 2007

(51) Int. Cl. G11B 5/09

(52) U.S. Cl. 360/59

(57) ABSTRACT

A hard disk drive that includes a head coupled to a disk. The head has a heater element. The drive also includes a controller that causes the heater element to heat the head to a temperature sufficient to anneal material within the head. The head is heated to a temperature sufficient to cause oxidation of any metal, such as aluminum, within the head, and/or oxygen redistribution and homogenization in the barrier. This heating process preferably occurs while the drive is not writing or reading data and the head is off disk.

### BACKGROUND OF THE INVENTION

1. Field of the Invention

The present invention relates to recovering data from a disk of a hard-disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

The disks are rotated by a spindle motor of the drive. Rotation of the disks creates an air flow within the disk drive. Each head has an air bearing surface that cooperates with the air flow to create an air bearing between the head and the adjacent disk surface. The air bearing eliminates or minimizes the mechanical wear between the head and the disk. The height of the air bearing is commonly referred to as the flying height of the head.

The magnetic field detected by the head is inversely proportional to the flying height of the head. Likewise, the strength of the magnetic field written onto the disk is also inversely proportional to the fly height. A larger fly height will produce a weaker magnetic field on the disk.

There have been developed heads that include a heater element. Current is provided to the heater element to generate heat and thermally expand the head to move the read and write elements closer to the disk. These types of heads are sometimes referred to as fly on demand (“FOD”) heads. The flying height of FOD heads can be varied by changing the amount of power provided to the heater element.

Errors may occur when reading data from the disk. There have been developed various schemes to detect and recover errors. Such schemes typically recover transient errors that occur during the write or read operations of the drive. Structural defects in drive components may cause data errors that cannot be recovered. For example, the heads may have insulator material constructed from aluminum oxide. Residual non-oxidized aluminum may remain within the heads. The residual aluminum degrades the performance of the heads and cause errors in the writing of data.

### BRIEF SUMMARY OF THE INVENTION

A hard disk drive that includes a head coupled to a disk. The head has a heater element. The drive also includes a controller that causes the heater element to heat the head to a temperature sufficient to anneal material within the head.

### BRIEF DESCRIPTION OF THE DRAWINGS

FIG. 1 is a top view of an embodiment of a hard disk drive;

FIG. 2 is a top enlarged view of a head of the hard disk drive;

FIG. 3 is a schematic of an electrical circuit for the hard disk drive;

FIG. 4 is a flowchart showing an error recovery scheme.

### DETAILED DESCRIPTION

Disclosed is a hard disk drive that includes a head coupled to a disk. The head has a heater element. The drive also includes a controller that causes the heater element to heat the head to a temperature sufficient to anneal material within the head. The head is heated to a temperature sufficient to transform residual aluminum into aluminum oxide. This heating process preferably occurs while the drive is not writing or reading data and the head is off disk.

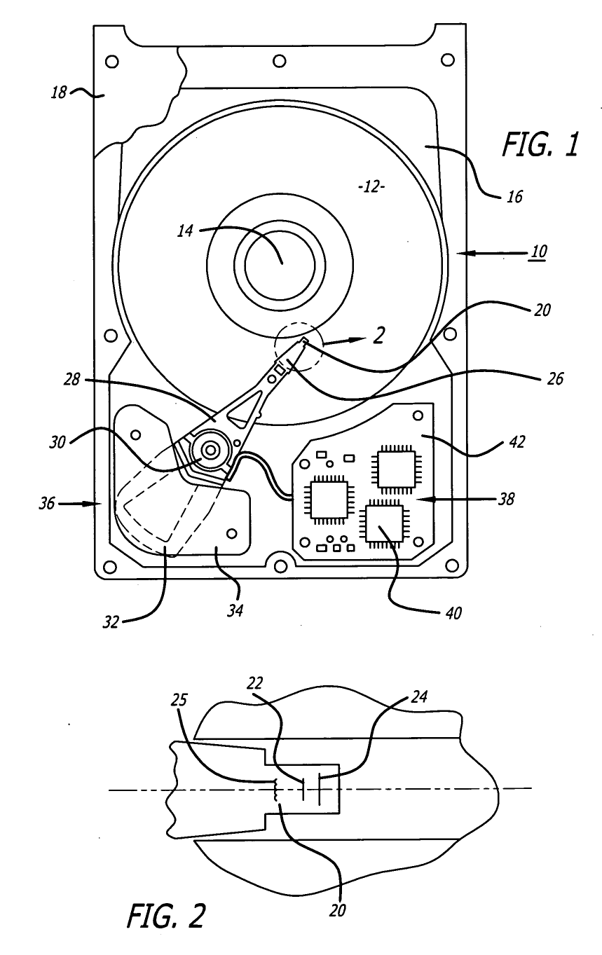

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. As shown in FIG. 2 the heads 20 may have separate write 22 and read elements 24. The write element 22 magnetizes the disk 12 to write data. The read element 24 senses the magnetic fields of the disks 12 to read data. By way of example, the read element 24 may be constructed from a magneto-resistive material that has a resistance which varies linearly with changes in magnetic flux. The head 20 may be a perpendicular recording head. Each head also has a heater element 25. The heater element 25 may receive current that generates heat in the head. The heat cause the head to thermally expand and varies the fly height. Such heads are commonly referred to fly on demand (“FOD”) heads.

Referring to FIG. 11 each head 20 may be gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 42 is coupled to the voice coil 32, heads 20 and spindle motor 14 by wires (not shown).

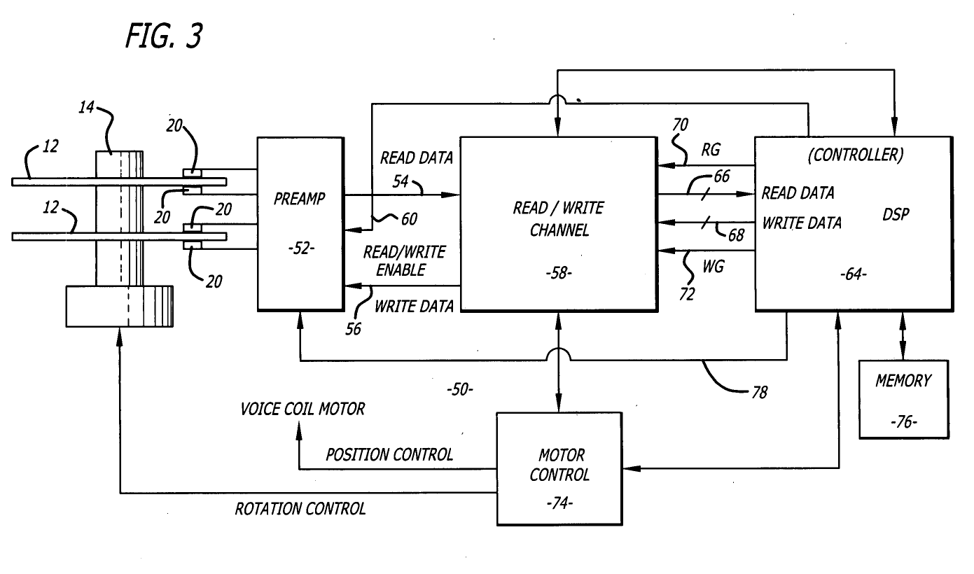

FIG. 3 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”). The non-volatile memory 76 may contain the instructions to operate the controller and disk drive. Alternatively, the controller may have embedded firmware to operate the drive.

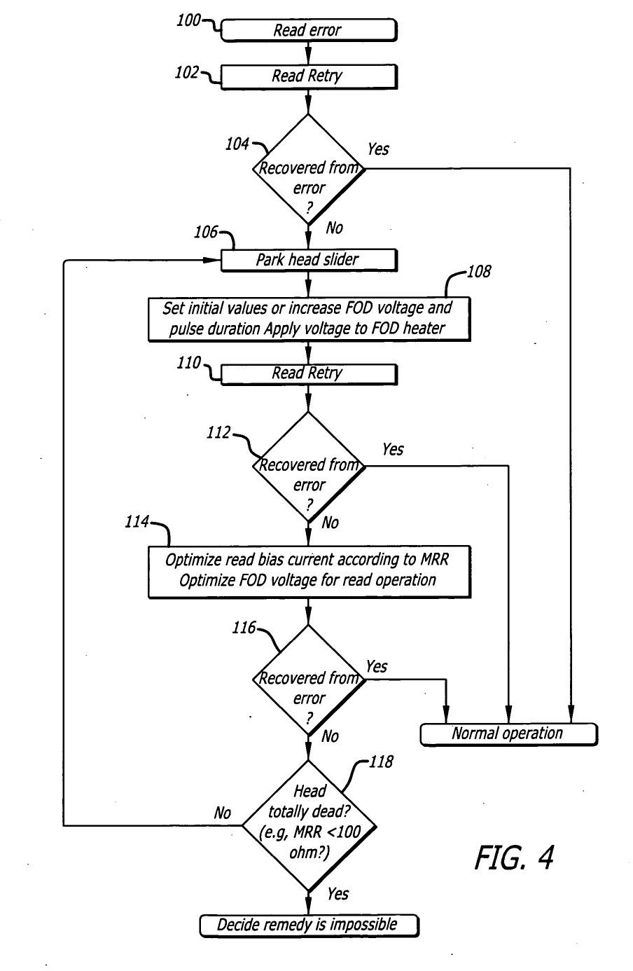

FIG. 4 is a flowchart used to recover data from the disk. The flowchart shows a process that can be performed by the drive controller. In step 100 data is read and one or more errors are detected. In step 102 the data is read again. In decision block 104 it is determined whether the error occurred again after the second try. If not, the process ends. If the data is not recovered then the head is moved away from the data in step 106. The head is typically moved to a location off the disk.

In step 108 a voltage is applied to the heater element to cause a current to flow therethrough. The voltage can be set at an initial value or the voltage can be increased from a present value for a certain pulse duration. The current generates heat that elevates the temperature of the head. The head is heated to a temperature sufficient to anneal material within the head. For example, the head can be heated to a temperature at least 250° C. Such a temperature will cause oxidation of metal, such as aluminum, within the head, and/or oxygen redistribution and homogenization in the barrier. Such oxidation or oxygen redistribution improves the insulating barrier of the head.

In step 110 data is again read from the disk after the head has cooled to an operating temperature. In decision block 112 it is determined whether the data is recovered. If so, the process ends. If not, the process continues to step 114, where the read current and heating element voltage are optimized. In step 116 the data is re-read and it is determined whether the data is recovered. If so, the process is complete. If not, the process continues to decision step 118 where it is determined whether the head is completely defective. This determination can include a measurement of the head element resistance. For example, if the resistance is below a threshold value the head may be deemed totally defective. If the head is not deemed totally defective the process returns to step 106 and is repeated.

The process allows an operational disk drive to self-anneal head material without removing the head and placing the same within an oven or other heating apparatus.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a disk;
a head that is coupled to said disk, said head has a heater element; and,
a controller that causes said heater element to heat said head to a temperature sufficient to anneal material within said head.

2. The disk drive of claim 1, wherein said controller determines an error in data read from said disk and causes said heater element to heat said head after determining the error.

3. The disk drive of claim 1, wherein said head is heated to a temperature that causes oxidation of a metal within said head.

4. The disk drive of claim 3, wherein said temperature is at least 250 degrees celsius.

5. The disk drive of claim 1, wherein said controller causes said head to be moved away from data of said disk before said heater element heats said head.

6. A hard disk drive, comprising:
a disk;
a head that is coupled to said disk; and,
means for heating said head to a temperature sufficient to anneal material within said head.

7. The disk drive of claim 6, wherein an error in data read from said disk is determined before said head is heated.

8. The disk drive of claim 6, wherein said head is heated to a temperature that causes oxidation of a metal within said head.

9. The disk drive of claim 8, wherein said temperature is at least 250 degrees celsius.

10. The disk drive of claim 6, wherein said head is moved away from data of said disk before said heater element heats said head.

11. A method for recovering data from a disk of a hard disk drive, comprising:
determining an error in data read from a disk by a head;
heating the head to a temperature sufficient to anneal material within the head; and,
reading the data from the disk.

12. The method of claim 11, further comprising moving the head away from the data before the head is heated.

13. The method of claim 11, wherein the head is heated to a temperature that causes oxidation of a metal within said head.

14. The method of claim 13, wherein the head is heated to a temperature of at least 250 degrees celsius.
